(19) United States
(12) Patent Application Publication
(10) Pub. No.: US 2008/0008830 A1
(43) Pub. Date: Jan. 10, 2008

(54) Method for forming colored oxide film layer on nickel plating or chrome plating layer

(76) Inventor: Young Hee Kim, Busan (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,210

(22) Filed: Jan. 16, 2007

(30) Foreign Application Priority Data
Jul. 4, 2006 (KR) 10-2006-0062311

(51) Int. Cl. B05D 5/06; B05D 3/02

(52) U.S. Cl. 427/162; 427/383.1

(57) ABSTRACT

The present invention provides a method for forming a colored oxide film layer on the surface of an article made of iron or a non-iron metal, by subjecting a nickel plating or chrome plating layer formed on the surface of the article to oxidizing heat treatment, in order to impart high corrosion resistance and a variety of vivid colors to the article. The method for forming a colored oxide film layer according to the present invention comprises the steps of: (a) subjecting an article made of iron or a non-iron metal to nickel plating or chrome plating; and (b) subjecting the article thus treated in step (a) to oxidizing heat treatment in an oxidizing atmosphere at 200 to 500° C. for 1 minute to 20 hours, to form a colored oxide film layer on the surface of the plating layer.

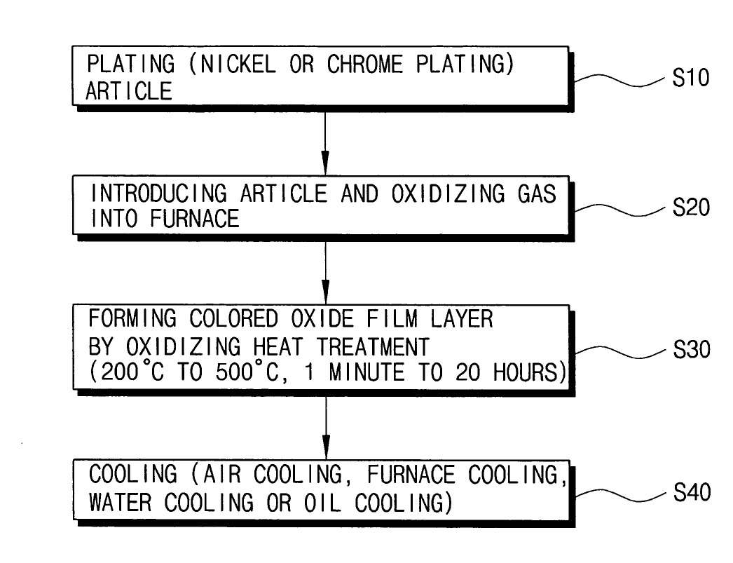

### BACKGROUND OF THE INVENTION

1. Field of the Invention

The present invention relates to a method for forming a colored oxide film layer on the surface of an article, by subjecting a nickel plating or chrome plating layer formed on the surface of the article to oxidizing heat treatment, in order to impart a variety of vivid colors with excellent decorativeness to the article.

2. Description of the Related Art

Along with the development of industries and enrichment in lifestyle, there is an increasing demand for new materials which still have the characteristics inherent to metals and additionally have excellent functions and high added values, as well as colored materials displaying a variety of color tones.

To this end, the inventors of the present invention have developed a technique which allows manifestation of various colors by applying an oxidizing heat treatment technique to nickel-plated or chrome-plated articles.

In this regard, development of various colors has been conventionally performed by applying a color paint directly on the surface of an article, by coating the surface of an article with a color coating composition followed by heat-treating the article, or by immersing an article in a metal plating solution to develop the color inherent to the metal or metal compound dissolved in the plating solution.

However, these conventional methods have problems such as discoloration over time, environmental pollution due to the use of plating solutions, limitation in developing a variety of colors, and inferior corrosion resistance.

While a method of obtaining gold color by plating an article with gold is excellent in providing excellent corrosion resistance and decorativeness, the method has problems such as that high treatments costs are required, and that only gold color is obtainable.

### SUMMARY OF THE INVENTION

The present invention has been designed to solve such problems of prior art, and thus, an object of the present invention is to provide a method for forming a colored oxide film layer having a variety of vivid and highly decorative colors with superior reproducibility at lower treatment costs compared to the prior art.

Other objects and advantages of the present invention will be described in the following, and will be further revealed by Examples of the present invention.

The method of the present invention comprises the steps of: (a) subjecting an article to nickel plating or chrome plating; and (b) introducing the article thus treated in step (a) and an oxidizing gas into a furnace, and subjecting the article to oxidizing heat treatment at a temperature of 200 to 500° C. for 1 minute to 20 hours, to form a colored oxide film layer on the surface of the plating layer.

Here, the article treated in the step (a) may be formed of any material which is capable of nickel plating or chrome plating, including all of iron-based materials as well as non-iron metals such as aluminum, copper and the like, or any material which does not undergo melting or deformation at a temperature of 500° C. or above when formed into an article.

The process of nickel plating in the step (a) can be performed by any of conventional nickel plating methods such as electroplating, electroless plating and the like, while the process of chrome plating can be performed by any of conventional chrome plating methods such as hard chrome plating, decorative chrome plating and the like.

The oxidizing gas that can be used in the step (b) to form a colored oxide film layer on the surface of a plating layer may be any oxidizing gas such as oxygen, air, carbon dioxide, steam or the like, which may be used individually or as a mixture of two or more species. It is also possible to add nitrogen gas to the oxidizing gas.

The color of the colored oxide film layer formed after the oxidizing heat treatment in the step (b) can be manifested as gold, purple, blue, yellow-green or the like in accordance with the temperature, time and atmosphere of the oxidizing heat treatment.

According to the present invention constituted as such, since colored oxide film layers are formed by performing oxidizing heat treatment using an oxidizing gas, a variety of vivid and highly decorative colors which cannot be developed by conventional methods can be manifested.

The constituent component of the colored oxide film layer formed on the surface is NiO in the case of using a nickel-plated article, and is Cr₂O₃ in the case of using a chrome-plated article. Since these components have high hardness, they are unlikely to generate defects on the surface upon use or handling of the treated article, thus not causing any deterioration in the decorativeness or corrosion resistance.

### BRIEF DESCRIPTION OF THE DRAWINGS

The FIGURE is a flow diagram showing a method for forming a colored oxide film layer according to an embodiment of the present invention.

### DETAILED DESCRIPTION OF THE INVENTION

Hereinafter, the present invention will be described in more detail with reference to the attached drawing.

The FIGURE is a flow diagram showing a method for forming a colored oxide film layer according to an embodiment of the present invention.

First, the method of the present invention includes a process of subjecting an article to nickel plating or chrome plating (S10), so as to improve the corrosion resistance of the article.

Then, the article thus treated by the plating process, and an oxidizing gas are introduced into a furnace (S20), to perform a process of coloring.

The process of coloring is to form a colored oxide film layer on the surface of the plated article by subjecting the surface of the plating layer to oxidizing heat treatment (S30), and the oxidizing heat treatment is performed at a temperature ranging from 200 to 500° C. for 1 minute to 20 hours in accordance with the color to be manifested.

If the temperature of the oxidizing heat treatment is lower than 200° C., the oxidizing heat treatment may not be performed properly, thus causing a failure in obtaining a desired colored oxide film layer. If the temperature of the oxidizing heat treatment is higher than 500° C., the resulting colored oxide film layer is black at all temperatures.

Furthermore, if the duration of the oxidizing heat treatment is shorter than 1 minute, the time needed for an oxide film layer to be formed may be insufficient, thus making it difficult to obtain a uniform colored oxide film layer. If the duration of the oxidizing heat treatment is longer than 20 hours, the extra time taken is unnecessary in view of economic efficiency.

The color of the colored oxide film layer formed after the oxidizing heat treatment can be manifested as gold, purple, blue or green in accordance with the temperature, time and atmosphere of the oxidizing heat treatment, and colors that are intermediate between the above-mentioned colors are also developed.

It is preferable that the thickness of the colored oxide film layer is from 0.005 μm to 5 μm, because the thickness of the surface oxide film layer affects scattering or interference of light, thus resulting in variation of the color to be manifested.

Thereafter, the article on which the colored oxide film layer has been formed through the above-described oxidizing heat treatment is then cooled by any one method selected from air cooling, furnace cooling, water cooling and oil cooling (S40).

The colors manifested by the method for forming a colored oxide film layer according to the present invention are varied and vivid, since the colors are developed as a result of oxidation of a nickel plating or chrome plating layer, into various colors ranging from gold, purple, blue and yellow-green to their intermediate colors according to different conditions of the oxidizing heat treatment. The articles thus treated by the method also attain excellent corrosion resistance. Thus, the articles having colored oxide film layers can be applied to a wide range of applications including interior decoration materials, various structures and construction materials.

Meanwhile, the heat treatment used for the oxidizing heat treatment may be performed using a pit type furnace, a sealed quench furnace, a fluidized bed furnace, or a continuous furnace consisting of one or more chambers, but any other furnaces can also be used as long as they can satisfy the oxidizing heat treatment conditions.

According to the present invention, in addition to the aforementioned oxidizing heat treatment methods, it is also possible to form a colored oxide film layer by applying a high frequency induction heating method. When the high frequency induction heating method is applied, the article can be heated to a predetermined temperature within a short time, and thus, the colors can be developed within a short time of about 10 seconds to 30 minutes in the presence of the aforementioned oxidizing gas at the aforementioned temperature.

As discussed above, the method for forming a colored oxide film layer of the present invention is capable of developing a variety of colors which cannot be developed by conventional methods such as a method of coating and heat-treating, an electroplating method and the like; requires low processing costs; is unlikely to generate surface defects; and is capable of developing colors with excellent decorativeness.

### EXAMPLE 1

A nickel-plated article formed of steel was subjected to oxidizing heat treatment in an air atmosphere at 320° C. for 6 hours, and then to air cooling. As a result, a gold-colored oxide film layer was formed thereon. When the same oxidizing heat treatment was performed for 10 hours, a dark gold-colored oxide film layer was obtained.

### EXAMPLE 2

A nickel-plated article formed of steel was introduced into a furnace and subjected to oxidizing heat treatment in a steam atmosphere at 320° C. for 6 hours, and then to air cooling. As a result, a colored oxide film layer having the same gold color as that of Example 1 was formed on the surface.

### EXAMPLE 3

A nickel-plated article formed of steel was placed in a furnace and subjected to oxidizing heat treatment in an air atmosphere at 360° C. for 8 hours, and then to air cooling. As a result, a yellow green-colored oxide film layer was formed on the surface.

### EXAMPLE 4

A nickel-plated article formed of steel was subjected to oxidizing heat treatment in a furnace at 360° C. in an air atmosphere for 4.5 hours, and then to water cooling. As a result, the color manifested on the surface of the article was blue.

### EXAMPLE 5

A chrome-plated article formed of steel was subjected to oxidizing heat treatment in an air atmosphere at 440° C. for 5 hours, and then to air cooling. As a result, a gold-colored oxide film layer was formed.

The method for forming a colored oxide film layer according to the present invention as described above provides the following effects.

First, since a variety of colors which cannot be developed by conventional methods can be developed by the method of the present invention, articles having a variety of vivid colors with excellent decorativeness are obtained, and can be used in a wide range of applications.

Secondly, since colors can be developed through processes that are simple compared to conventional methods, the products costs are low.

Thirdly, the surface hardness of the articles treated by the present invention is higher than that of the articles treated by conventional methods, and thus the articles are unlikely to have surface defects, are corrosion-resistant, and can prevent deterioration of decorativeness.

As described above, although the present invention has been explained by a limited number of Examples and drawing, the present invention is not restricted thereby. Furthermore, various corrections and modifications can be provided by those having ordinary skill in the technical field to which the present invention pertains, within the technical ideas of the present invention and within a scope equivalent to the claims that follow.

What is claimed is:

1. A method for forming a colored oxide film layer, the method comprising the steps of:
(a) subjecting an article to nickel plating or chrome plating; and
(b) subjecting the article thus treated in step (a) to oxidizing heat treatment in an oxidizing atmosphere at 200 to 500° C. for 1 minute to 20 hours, to form a colored oxide film layer on the surface of the plating layer.

2. The method according to claim 1, wherein the article is formed of any of materials that are capable of nickel plating or chrome plating, such as iron-based materials and non-iron metals such as aluminum, copper and the like, or any material which does not undergo melting or deformation at a temperature above 500° C. when formed into an article.

3. The method according to claim 1, wherein the process of nickel plating is performed by any one of nickel plating methods, including electroplating, electroless nickel plating and the like, while the process of chrome plating is performed by any one of chrome plating methods selected from hard chrome plating, decorative chrome plating and the like.

4. The method according to claim 1, wherein the oxidizing atmosphere comprises any one of oxidizing gases such as oxygen, air, carbon dioxide, steam and the like, either used individually or as a mixture of two or more species.

5. The method according to claim 1, wherein the process of oxidizing heat treatment is performed using a pit type furnace, a sealed quench furnace, a fluidized bed furnace, or a continuous furnace consisting of one or more chambers.
